(19) United States
(12) Patent Application Publication
(10) Pub. No.: US 2005/0288858 A1
(43) Pub. Date: Dec. 29, 2005

(54) Mecca finder

(76) Inventors: Osama A. "Sam" Amer, Dacula, GA (US); Roy L. Kerfoot JR., Lilburn, GA (US)

Correspondence Address: MOTOROLA INC, 600 NORTH US HIGHWAY 45, ROOM AS437, LIBERTYVILLE, IL, 60048-5343, US

(21) Appl. No.: 10/880,036

(22) Filed: Jun. 29, 2004

(51) Int. Cl. G01C 21/26

(52) U.S. Cl. 701/211; 701/210; 701/224

(57) ABSTRACT

A portable electronic device, like a cellular telephone for example, includes software for executing a method for presenting directional indicator information to a user on a display. The device receives geographical information about its location, orientation information of its alignment and geographical information about a landmark of interest. The device then calculates a destination angle relative to the orientation information. The device then presents directional information, for example an arrow, to a user. In one exemplary application, Muslims are able to select Mecca as the landmark of interest. The device then uses information about its own location, the orientation of the device and the location of Mecca to present an arrow on the display indicating the proper direction for the Muslim to align themselves for prayer in accordance with the teachings of Islam.

### BACKGROUND

1. Technical Field

This invention relates generally to a method of presenting information to a user of a portable electronic device, like a radiotelephone, and more particularly to a method for presenting directional information to a user based upon geographical information of a landmark of interest.

2. Background Art

Direction has long been an important concept to man. Laurence J. Peter once said, “If you don't know where you are going, you will probably end up somewhere else.” Thomas Paine said, “It is the direction and not the magnitude that is to be taken into consideration.” In every task from sailing a vessel to watching the sunset, knowledge of which direction to align oneself is imperative for the task to be accomplished properly.

Examples of the need for direction abound. It is rumored, for example, that Winston Churchill would bow to the south, in the direction of France, prior to consuming a Martini. His bow, as the story goes, was in gratitude for the fine vermouth he enjoyed with his gin. To properly pay his respects, he always needed to know which way to turn to face France, regardless of the room or building in which he was enjoying his Martini.

Another example, in which directional information is extremely important, is for followers of the teachings of Islam. The Muslim faith requires that its followers pray five or more times per day. With each prayer, the faith teaches that the follower is to face the Kabaa, which is a shrine situated on the courtyard of the Great Mosque in Mecca. As such, each Muslim needs to know which way to turn to face Mecca prior to prayer, several times daily. With over 1.7 billion Muslims in the world, the need for this directional information is great.

One prior art solution, employed by Muslims in North America, is to simply turn to the east to pray. Since North America is roughly along the same latitude as Mecca, many people in North America generally turn to the east, presuming that this rough direction is “good enough”. The problem with this prior art solution is that to face the east, one must know at least one navigational direction, i.e., north, south, east or west. In today's hectic lifestyle, it is often difficult to tell which direction you are facing. This is especially true when in a building without windows, or when traveling to an unfamiliar city.

Another prior art solution is to attempt to calculate the direction of Mecca solely from Global Positioning System (GPS) coordinates. However, this method is flawed because it is impossible to tell a person in which direction to face based upon a single location alone.

There is thus a need for an improved method of presenting directional information to a user.

### BRIEF DESCRIPTION OF THE DRAWINGS

FIG. 1 illustrates one preferred device in accordance with the invention.

FIG. 2 illustrates a schematic block diagram of the device of FIG. 1.

FIG. 3 illustrates one preferred method for presenting directional indicator information in accordance with the invention.

FIG. 4 illustrates one preferred method for presenting directional indicator information in accordance with the invention.

FIG. 5 illustrates an environment in which a device in accordance with the invention may communicate with other devices.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

This invention provides a portable electronic device, like a cellular telephone for example, capable of providing a directional indicator to a user. In one preferred embodiment, the device provides a directional indicator to a landmark of interest. One example of such a landmark of interest would be Mecca in Saudi Arabia.

Software operating within the electronic device determines the location of the device, the orientation of the device, and the location of the landmark of interest. The software then uses this information to calculate a destination angle, which is the angle between the directional indicator and the relative orientation of the device. The software then presents a directional indicator, for example an arrow, to a user on a display.

For instance, if a Muslim is about to pray, he or she simply actuates software within an electronic device that executes the method of the present invention. The software then presents a directional indicator to the user pointing the way to Mecca. The user then knows which way to align his body prior to prayer.

In one preferred embodiment, the directional indicator feature is one of a plurality of features stored in a cellular telephone. A user calls up the directional indicator feature by selecting it from a menu of options. When the feature is selected, the device then displays a directional indicator on the display of the phone.

Advantages of the present invention include its accuracy and ease of use. The accuracy is provided in part by the destination angle that is calculated. Earlier patents have attempted to provide such a directional indicator, but have been ineffective. For example, U.S. Pat. No. 6,202,035, issued to Lameer, entitled “System for Determining Time or Direction for Prayer” teaches a directional indicator that is computed “ . . . directly from [the] GPS signals . . . ” The problem with such a system is that it fails to take into account the relative orientation of the system. Using only GPS signals, the system of the '035 patent is unable to change the display presentation when the system is moved. For example, if a user enters data with the device pointing NNW, and then shifts the device to NNE, GPS signals provide no realignment compensation.

The present invention, by contrast, offers an improvement in that by calculating a destination angle, the display can be continually updated as the orientation of the device changes. Additionally, the present invention is easily incorporated into devices like cellular telephones, thereby eliminating the need to purchase expensive, stand alone devices.

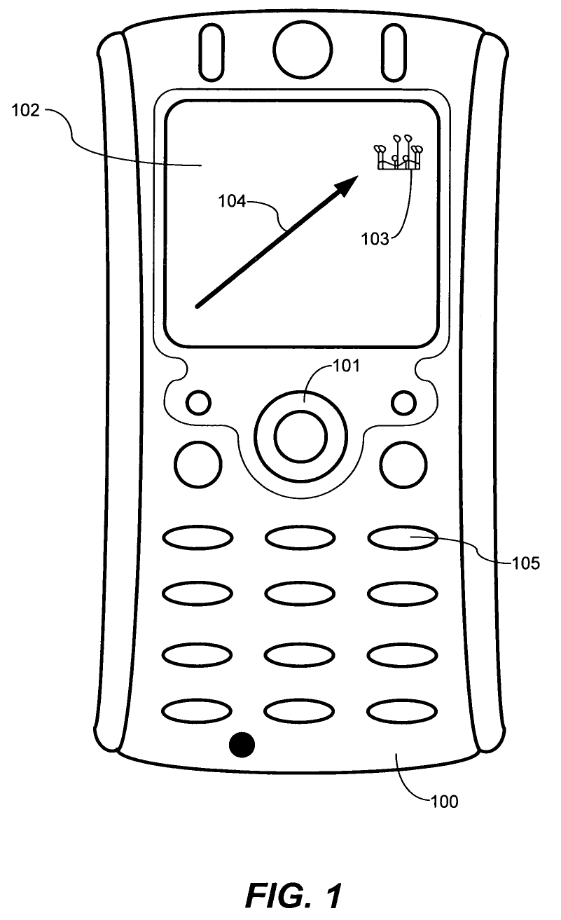

Turning now to FIG. 1, illustrated therein is a portable electronic device 100 in accordance with the invention. In this exemplary embodiment, the portable electronic device 100 comprises a radiotelephone, but it will be clear to those of ordinary skill in the art having the benefit of this disclosure that the invention is not so limited. It could easily be implemented in a variety of devices, including radios, pagers, PDAs, MP3 players, laptop computers, video recorder/players, and the like.

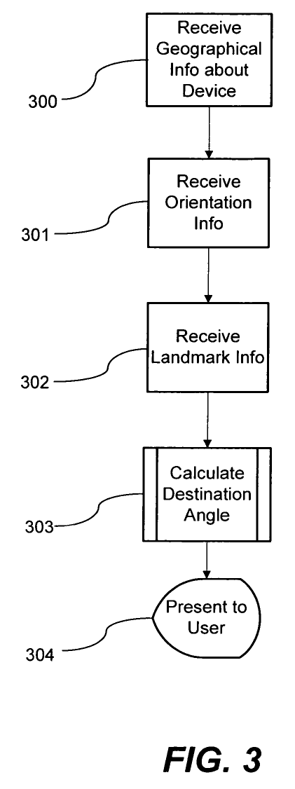

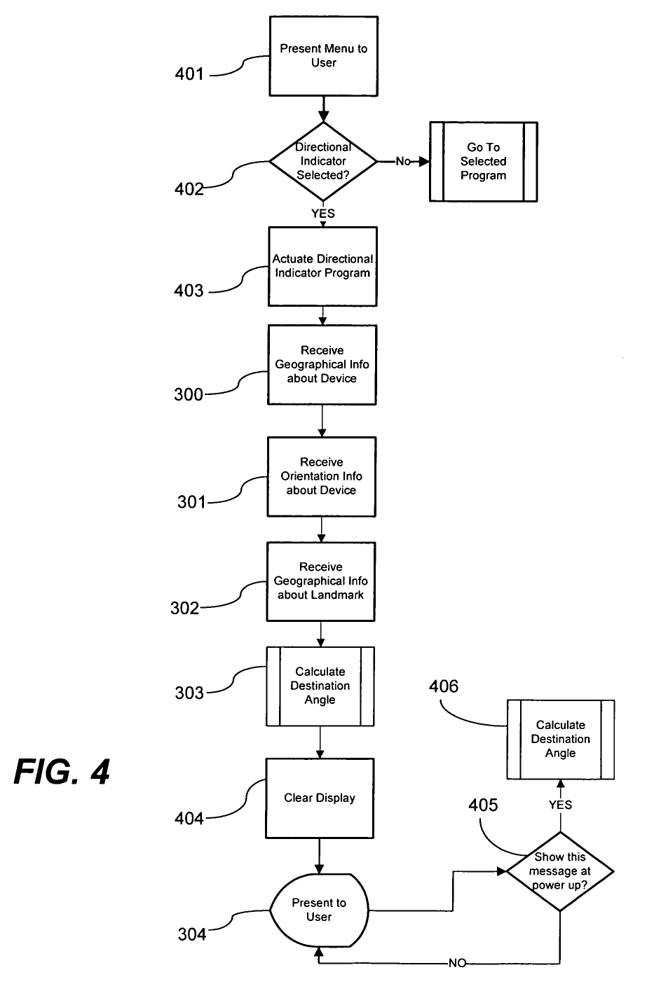

The phone 100 includes a display 102, upon which a directional indicator 104 may be presented to a user. The phone 100 may include a keypad 105 for traditional phone operation, as well as special, shortcut keys 101 for actuating menus of functions or features offered by the phone 100. When one of the methods is employed in accordance with the invention, like those described below with respect to FIGS. 3 and 4, a directional indicator 104 is presented upon the display 102. The directional indicator 104 may be as simple as an arrow (shown here), or may be some other graphical representation of direction. Additionally, if the directional indicator 104 is set to point to a specific landmark of interest, a graphical representation 103 of the landmark of interest may be presented on the display 102 as well.

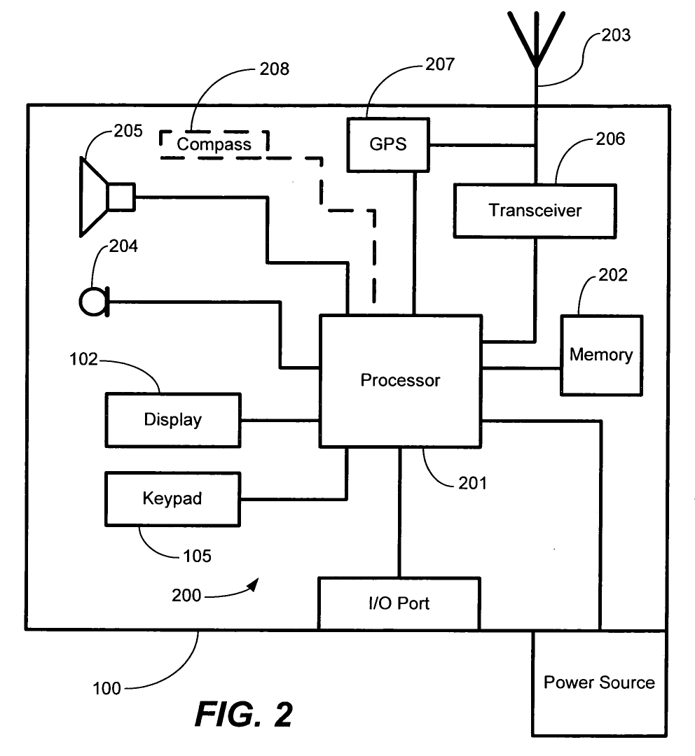

Turning now to FIG. 2, illustrated therein is a circuit block diagram illustrating one preferred embodiment of the circuitry associated with a radiotelephone 100 shown in FIG. 1. The system 200 includes a microprocessor 201, which serves as the device's central processing unit. A memory module 202 is coupled to the microprocessor 201. Software, or “firmware” code, which is executable by the microprocessor 201, is disposed within the memory 202. The software stored within the memory 202 includes commands and instructions corresponding to a plurality of steps for presenting the directional indicator upon the display 102. These steps will be discussed in more detail with respect to FIGS. 3-4 below.

The device 100, as noted above, includes a display 102 and keypad 105. Other standard components include an antenna 203, a microphone 204, a speaker 205 and an amplification transceiver 206 for transmitting communication signals to a network. While these components are included when the device comprises a cellular telephone, some of these components may not be necessary when the invention is employed in the other devices mentioned above. When the information is presented on the display 102, in one preferred embodiment the information is maintained on the display 102 until the user depresses a key on the keypad 105, or otherwise inputs information into the device 100.

Prior to presenting the directional indicator to the user, the software must receive information about its current location. One way to do this is with the optional GPS receiver 207. Other ways, including cellular and terrestrial trilateration, may be substituted. Additionally, orientation information about the alignment of the device must be known prior to presenting the directional indicator. One way of receiving this information is by way of an optional electronic compass 208.

Turning now to FIG. 3, illustrated therein is one preferred method of presenting a directional indicator in accordance with the invention. At step 300, geographical information is received by the device. This information generally takes the form of a latitude, longitude and perhaps altitude, and may be received by any of a number of ways. It may be directly received by way of the optional GPS receiver (207). It may also be received by terrestrial trilateration, in which a service provider determines the location of the device by detecting between which three or more transmission towers the device is located.

Alternatively, the information may be stored within the device as a constant. For example, if the user lives and works in Atlanta, a standard coordinate for Atlanta may be stored in the device and used in the calculation of the destination angle. The advantage of this method is that it reduces the overall cost of the system by eliminating the need for a GPS receiver. When this method is used, the device may query the user prior to presenting the directional information as follows: “Are you still in Atlanta? Enter Yes or No.” So long as the user indicates in the affirmative, the constant coordinate may be used.

Another way to receive the user information relating to the geographic location of the device is by user input. A user may simply type in the geographic coordinates of his location. In the alternative, a user may type in the name of a city, wherein the device will go to a locally stored or remotely stored system to retrieve the corresponding coordinates.

Once the geographic location of the device is received, the orientation of the device is received at step 301. The relative orientation is important because the software executing the method of the invention must know whether the device is pointing north, south, east, west, etc. In one preferred embodiment, the user either holds the device in the palm of the hand or sets the device on a flat surface like a table or the floor. The device must then determine, for example, if the antenna or top of the display is pointing due north, or in another direction. Once the destination angle is calculated, the device will use this orientation information to display the directional information properly.

The orientation information received at step 301 may be obtained in a variety of ways. Using the exemplary circuitry of FIG. 2, an electronic compass (208) may indicate North relative to the display. Alternatively, when the user is in motion, successive readings from the optional GPS receiver may indicate information about the alignment of the device.

Alternatively, the user may point one side of the display, for example the top, towards the north. If the user is outside, the user may align the device with the sun. If the alignment is provided by the user, this information will be input to the device via the keyboard 105.

At step 302, geographic location information relating to the landmark of interest is received. As with the other information, this information may be received from any of a variety of sources. A first source may be a programmed constant stored within the memory. For example, if a phone is offered to consumers having a “Mecca Finder” function, the phone manufacturer may simply store the geographical information relating to Mecca in the phone. Similarly, if another landmark were used, say Augusta National for golfers, the geographic information relating to that landmark may be stored. The latitudes and longitudes for most cities of the world are available at the website: http://www.astro.ch/atlas/atlquest-eng.html.

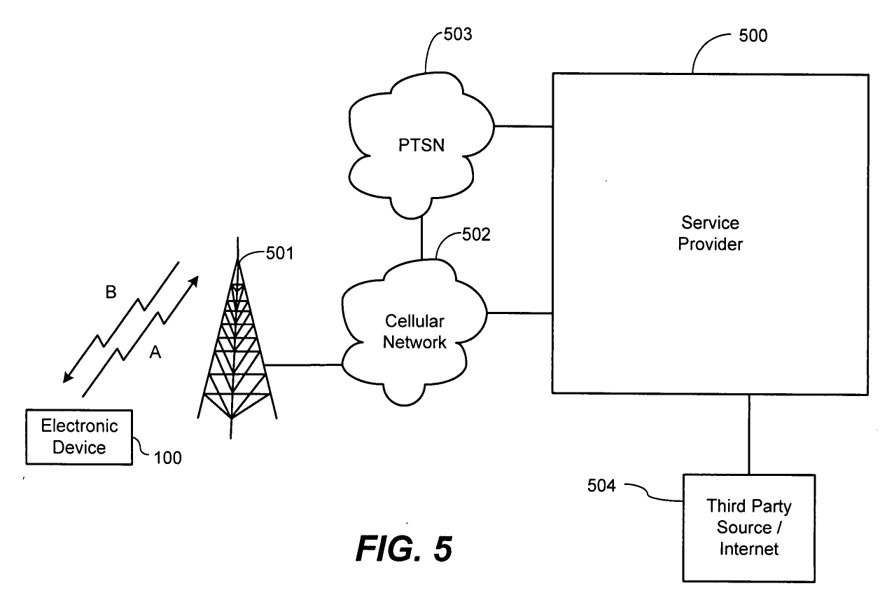

A second source for the information is either a locally stored or remotely stored look-up table. A look-up table having popular landmark geographic information may be provided either in the device's memory 202 or on a remote server, which will be discussed with respect to FIG. 5. When the user enters the name of one of the listed landmarks, the corresponding geographical information may be received from either the remote server or the device's memory 202.

A third source is manual entry. Given the easy access to the Internet, a user may prefer to look up the coordinates of a particular landmark of interest himself. The user may then simply enter or download that information into the device.

A fourth source of the information may be from the GPS receiver 207. When a user visits the particular location, the user may save the geographical location information received while present at the landmark of interest. At some future date, this geographical information may be recalled from memory.

A fifth source of the information is the internet or a third party service provider. As many electrical devices today are communication capable, the geographic information relating to the landmark of interest may be received by wireless communications from a third party service provider.

At step 303, the destination angle is calculated. It is the destination angle that is used to present the directional indicator on the display. Since the device knows the orientation of the device from step 301, the device applies the destination angle, relative to the orientation, to provide an accurate directional indicator.

An example of one preferred method of calculating the destination angle, using geographic coordinates of latitude and longitude, is shown below. The destination angle given using this method is relative to the north. Thus, if north is known, a directional indicator may be drawn relative to this reference, out of line with the north by the destination angle. This method is easily implemented in software, and is written as pseudo code to indicate such.

Known Parameters:
Pre_Dest=Destination Angle
LongP=Longitude of Present Location
LatP=Latitude of Present location
LongD=Longitude of Final Destination (Makka)
LatD=Latitude of Final Destination (Makka)

Relationship:
Pre_{—}Dest=Tan⁻¹[Sin(LongP−LongD)/(Cos(LatP)*Tan(LatD))−(Sin(LatP)*Cos(LongP−LongD))] [EQ. 1]

Note that where the landmark of interest is Mecca, the geographical coordinates are latitude 21° 27′ N and longitude 39° 49′ E. Note also that the destination angle may need modification depending upon the source from which the orientation information was received in step 301. The destination angle should be modified by the amount of magnetic declination because there can be two “norths”. One is the True North (TN) and the other is the Magnetic North (MN). The problem can arise when an electronic compass is the source of orientation information, because the equation shown above calculates the angle from the TN and the compass gives the angle from the MN. The difference between the two “norths” is called the Magnetic Declination (MD). As such, a compass reading needs to be modified and compensated by the value of this MD for the location. The values for these MDs may be stored in a look-up table and are available from the Canadian National Geophysical Laboratory website. Time of year may be required as well, as the MD varies slightly from year to year. The MD provided at the above site will be in terms of degrees and minutes east or west. If it is east variation, the true destination angle will be that slightly to the right of your magnetic compass measurement. If it is west then the MD gets added to your calculated angle to give the true angle to be measured on the magnetic compass.

Once the destination angle is calculated, it is set relative to the orientation information and presented as a directional indicator on the display at step 304. As stated above, the directional indicator may be as simple as an arrow. Enhancements may be added as well. For example, the directional indicator may blink when the device is being moved and the angle is being recalculated. Note that the method of FIG. 3 may be repeated to ensure that the directional indicator is correctly aligned when the device is rotated or moved.

Turning now to FIG. 4, illustrated therein is another preferred embodiment of a method in accordance with the invention. The method of FIG. 4 includes a menu option by which a user may actuate the directional indicator program stored in memory as software commands and instructions.

At step 401, a menu of programs or features is presented to a user. This presentation of the menu may be in response to the user pressing a menu button, like button 101 in FIG. 1. Once the menu is presented, the device waits at step 402 until a particular feature or program is selected. If the directional indicator program is selected the software of the device proceeds to step 403, where the directional indicator program is actuated.

Steps 300-304 are the same as in FIG. 3, and will not be restated here. One additional optional step, however, is step 404. At step 404, the screen is cleared prior to the presentation of the directional indicator at step 304. In some applications, it may be desirable to present only the directional indicator on the screen. In such cases, step 404 would be included. In other applications, perhaps where the display of the device is sufficiently large, status information—like time and date, for example—may be included on the display along with the directional indicator. In these applications, step 404 would be omitted.

To provide the user with control over the display, steps 405 and 406 provide a mechanism to return to the normal operating mode. For example, if the electronic device upon which the directional indicator program is running is a cellular telephone, steps 405 and 406 allow the user to return from the directional indicator program to cellular telephone operation.

At step 405, the device waits for input, for example a key being depressed. Once this input is received, the device returns to normal operating mode at step 406.

Turning now to FIG. 5, illustrated therein is a top-level block diagram of one environment in which an electronic device 100 may be used. As mentioned above, information like the geographic location of the device and the geographic location of the landmark of interest, may be received from sources like the internet or third-party service providers. To receive such information from these types of sources, the device 100 needs communications capabilities. For communications devices, like cellular phones for example, communication is generally carried on with a service provider having at least one service center 500.

In the system, the device 100 and the service center 500 may communicate with each other via wireless communications. The wireless communications are illustrated in FIG. 5 by communication arrows A and B. In one embodiment, the communication A is a cellular wireless communication that is transmitted to a base station antenna 501, through a cellular network 502 and a public switched telephone network (PSTN) 503, and to the service center 503. The service center 500 includes computers within which the third party safety messages may stored, in addition to service provider messages. Where the messages are from a third party, these messages are communicated to the service center 500 from that particular third party 504.

Those of ordinary skill in the art, having the benefit of this disclosure, will appreciate that many possible wireless communication methods may be used for communications from the device 100 to the service center 500. In one embodiment, the communications are via a cellular wireless communication such as AMPS, CDMA, GSM or TDMA. The transmission from the device 100 to the service center 500 may also be made by other wireless communications such as a satellite communications.

In response to receiving informational query from the device 100, the service center 500 may transmit any locally stored information to the device 100. In one embodiment, the communication B is a cellular wireless communication that is sent through the public switched telephone network (PSTN) 503 and cellular network 502 and transmitted by the base station antenna 501 to the device 100. The device may then display the information on the display.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

1. A method for displaying a directional indicator, the method comprising the steps of:
a. receiving geographical location information of a portable electronic device;
b. receiving orientation information of the portable electronic device;
c. receiving geographical location information of a landmark of interest;
d. calculating a destination angle; and
e. presenting a directional indicator upon a display.

2. The method of claim 1, wherein the geographical information of the portable electronic device is received from a source selected from the group consisting of a GPS receiver, a service provider, a memory disposed within the portable electronic device, and user input.

3. The method of claim 1, wherein the orientation information is received from a source selected from the group consisting of user input information, successive readings from a GPS receiver, and an electronic compass.

4. The method of claim 1, wherein the geographical information of the landmark of interest is received from a source selected from the group consisting of a memory disposed within the portable electronic device, Internet, a third party service provider, a look-up table, user input information and a GPS receiver.

5. The method of claim 1, wherein the directional indicator comprises an arrow.

6. The method of claim 1, wherein the directional indicator further comprises a graphical representation of the landmark of interest.

7. The method of claim 1, wherein the method is executed by software running in a cellular telephone.

8. The method of claim 1, wherein the landmark of interest is Mecca.

9. A radiotelephone, comprising:
a. a central processor;
b. a display coupled to the central processor; and
c. memory coupled to the central processor, the memory having operational software stored therein;
wherein the operational software comprises instructions for a method comprising the following steps:
i. determining the location of the radiotelephone;
ii. determining the location of a landmark of interest;
iii. determining the orientation of the radiotelephone;
iv. determining a destination angle; and
v. presenting a directional indicator to a user.

10. The radiotelephone of claim 9, wherein the step of determining the location of the radiotelephone is selected from the group consisting of receiving information from a global positioning system, reading information from a look-up table, receiving information from a cellular service provider, and receiving user input.

11. The radiotelephone of claim 9, wherein the directional indicator comprises an arrow.

12. The radiotelephone of claim 9, wherein the landmark of interest is Mecca.

13. A method for determining a direction to a landmark of interest, the method comprising:
a. presenting a menu of informational services on a display to a user, at least one of the informational services comprising a directional determination method;
b. actuating the directional determination method upon receiving a corresponding menu selection;
c. receiving geographical location data of an electronic device;
d. receiving orientation information about the display;
e. receiving geographical information of the landmark of interest;
f. calculating a destination angle;
g. removing information from the display; and
h. presenting a directional indicator on the display.

14. The method of 13, further comprising the steps of:
a. waiting for a user input;
b. upon receiving the user input, returning the display to a normal operating mode.

15. The method of claim 13, wherein the step of receiving geographical location data of the electronic device is selected from the group consisting of receiving information from a global positioning system, reading information from a look-up table, receiving information from a cellular service provider, and receiving user input.

16. The method of claim 13, wherein the geographical information of the landmark of interest is received from a source selected from the group consisting of a memory disposed within the portable electronic device, Internet, a third party service provider, a look-up table, user input information and a GPS receiver.

17. The method of claim 13, wherein the directional indicator comprises an arrow.

18. The method of claim 13, wherein the method is executed by software operating on a portable electronic device.

19. The method of claim 1n-1, wherein the portable electronic device comprises a cellular telephone.

20. The method of claim 13, wherein the landmark of interest is Mecca.
